(19) United States
(12) Patent Application Publication
(10) Pub. No.: US 2023/0359870 A1
(43) Pub. Date: Nov. 9, 2023

(54) Digital Information-Theoretic Code From Analog Scanning Technology Using Deep Networks

(71) Applicant: Northeastern University, Boston, MA (US)

(72) Inventors: Ravi Sundaram, Brookline, MA (US); Akshar Varma, Boston, MA (US); Mansoor M. Amiji, Attleboro, MA (US); Ogheneyunume Fitchorova, Acton, MA (US); Brian Lejeune, Chepachet, RI (US); Laura Henderson Lewis, Boston, MA (US); Xiaoyu Zhang, Waltham, MA (US)

(21) Appl. No.: 18/312,870

(22) Filed: May 5, 2023

Related U.S. Application Data
(60) Provisional application No. 63/364,230, filed on May 5, 2022.

(51) Int. Cl. G06N 3/0455

(52) U.S. Cl. CPC G06N 3/0455

(57) ABSTRACT

A network provides for encoding and decoding messages. An encoder neural network (NN) generates a tag description based on an input message. A compute module generates a distorted signature based on the tag description and a noise model. A decoder NN generates an output message based on the distorted signature. A controller compares of the input message and the output message. If an error is detected in the output message, the controller causes the encoder NN to be updated based on the error.

### RELATED APPLICATION

This application claims the benefit of U.S. Provisional Application No. 63/364,230, filed on May 5, 2022. The entire teachings of the above application are incorporated herein by reference.

### BACKGROUND

The need for securing supply chains has led to the invention of new scanning technologies based on novel substances and their properties such as DNA based encoding, fluorescent dyes, opto-chemical inks, magnetic microwires, and Raman spectroscopy. In addition to creating track-and-trace-tags, these scanning technologies can also be used for data storage and communication in niche scenarios where traditional technologies' capabilities fall short.

A fundamental and common problem arising in all scanning technology is one of efficient utilization of the materials to capture/store/communicate as much information as possible. The classical fields concerned with utilization of information and the transmission/storage of data are information theory and coding theory respectively. From a coding theory perspective, a scanning technology is the same as an analog channel which, traditionally, come under the purview of line coding and constrained codes. In many applications, scanning technology requires a constrained code because tags are limited by the possible configurations of the material when creating a code-word for any given message.

### SUMMARY

Example embodiments include a network for encoding and/or decoding messages. An encoder neural network (NN) may be configured to generate a tag description based on an input message. A compute module may be configured to generate a distorted signature based on the tag description and a noise model. A decoder NN may be configured to generate an output message based on the distorted signature. A controller may be configured to 1) detect an error based on a comparison of the input message and the output message, and 2) update the encoder NN based on the error.

The compute module may be further configured to generate a signature based on the tag description, and apply the noise model to the signature to generate the distorted signature. The controller may be further configured to update the decoder NN based on the error. The tag description may include instructions for generating a tag, the tag being a coded physical representation of the input message. The distorted signature may be configured to represent an output of the tag generated by a tag scanning device. The output represented by the distorted signature may be one of an image, a digital signal, and a spectrum.

The noise model may be one of an additive white gaussian noise model, a bit-flip model, and a Hamming noise model. The controller may update the encoder NN by modifying a size of a message corresponding to the tag description. The tag description may correspond to one of a matrix barcode, a radio-frequency identification (RFID) tag, a DNA code, an electronic ink code, a magnetic microwires tag, an optochemical ink tag, and a datacules code.

Further embodiments include a method of encoding messages. Via an encoder NN, a tag description may be generated based on an input message. A distorted signature may be generated based on the tag description and a noise model. Via a decoder NN, an output message may be generated based on the distorted signature. An error may be detected based on a comparison of the input message and the output message. The encoder NN may then be updated based on the error.

A signature may be generated based on the tag description, and the noise model may be applied to the signature to generate the distorted signature. The decoder NN may be updated based on the error. The tag description may include instructions for generating a tag, the tag being a coded physical representation of the input message. The distorted signature may be configured to represent an output of the tag generated by a tag scanning device. The output represented by the distorted signature may be one of an image, a digital signal, and a spectrum.

The encoder NN may be updated by modifying a size of a message corresponding to the tag description The noise model may be one of an additive white gaussian noise model, a bit-flip model, and a Hamming noise model. The tag description may correspond to one of a matrix barcode, a radio-frequency identification (RFID) tag, a DNA code, an electronic ink code, a magnetic microwires tag, an optochemical ink tag, and a datacules code.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram of a tag scanning system in which example embodiments may be implemented.

FIGS. 2A-B are diagrams of an encoder and decoder network in one embodiment.

FIG. 3 is a diagram of a network in a training configuration in one embodiment.

FIG. 4 is a diagram of a network in one embodiment.

FIG. 5 is a diagram of a process of generating a tag description on one embodiment.

### DETAILED DESCRIPTION

A description of example embodiments follows. The teachings of all patents, published applications and references cited herein are incorporated by reference in their entirety.

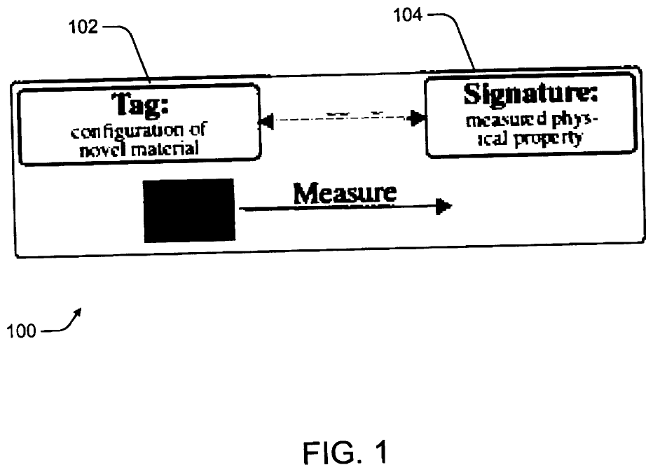

FIG. 1 illustrates a tag scanning system 100. A scanning technology such as the system 100 may operate as an analog channel that takes as input a tag 102, which is a physical configuration of material (e.g., a matrix barcode, a radio-frequency identification (RFID), or a spatial configuration of magnetic microwires) representing a message, and returns a signature 104, which is a readout captured by scanning the tag (e.g., a readout in the frequency domain, an image captured though an optical reader, a readout from a spectrum captured via an antenna, or via a mass spectrometer using a magnetic field). An important task is one of decoding, in which the input tag is identified given its output signature. However, due to noise and lack of ideal conditions during a scan of a tag, the signature of distinct tags may appear to be similar, causing ambiguity in the decoding process. This gives rise to the problem of efficiently generating a large collection of tags (order of millions or billions) that can be disambiguated quickly from their signatures. Concretely, the problem of efficient utilization in coding-theoretic terms can be stated as: given a scanning technology, create a constrained (error-correcting) code of high rate with efficient (polynomial-time) encoding and decoding algorithms.

Tagging systems made from novel materials (or combinations) may have a plethora of desirable properties not all satisfied by current systems. This requires disambiguating configurations of materials given their measured properties and using that to generate a large code that can be decoded despite the presence of noise.

As described herein, the specific arrangement of the novel material is referred to as the “configuration” of the “tag,” and the physical measurement is referred to as the “signature” corresponding to the “tag.” Mathematically, these elements can be abstracted as real or binary vectors; tags t∈T where Tis the set of all tags vectors of dimension T=|T|, similarly signatures s∈S where S is the set of all signature vectors of dimension S=|S|. The measurement function is denoted by ƒ: T→S, and a neural network model may be configured to approximate the behavior of ƒ, which can be used to access the measurement function during the training phase. The model utilizes an auxiliary vector r∈R of dimension R=|R| which is used learn a latent embedding of the signatures as well as to act as an indexing mechanism to valid code-words in the tagging system. The description herein uses shorthand notation c∈[a±b] to denote that c∈[a−b, a+b].

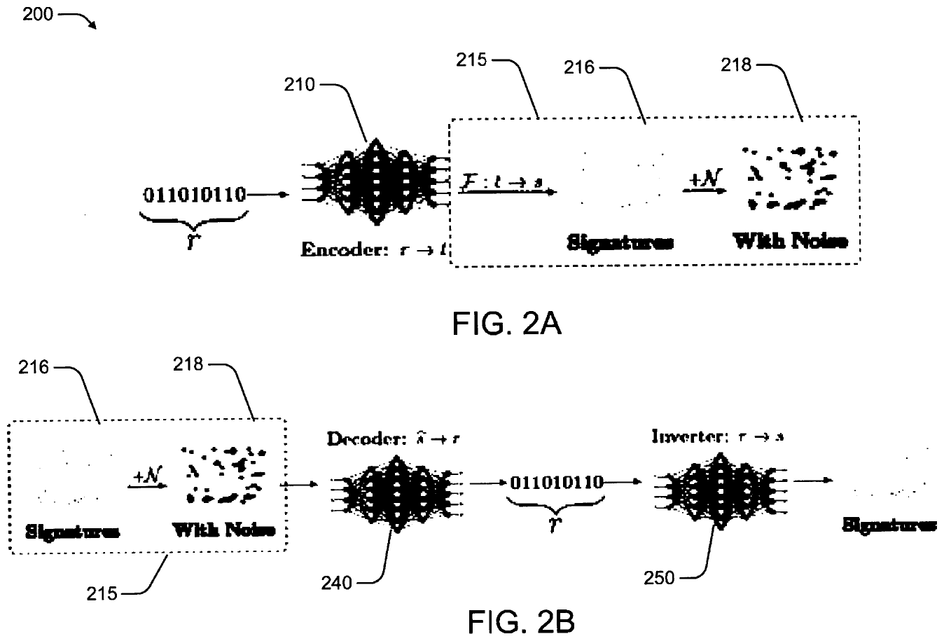

FIGS. 2A-B are diagrams of an encoder and decoder network 200 in one embodiment. The network 200 can be decomposed into four components, each solving a specific task. Each message may be a unique identifier (ID) corresponding to a respective tag. An encoder 210 maps random messages (in this example, bitstrings) r to the tags t. This set of tag configurations is then passed to the forward function block 215 that has been learned using the data to mimic the measurement function. This block 215 outputs a signature s of a signature array 216, to which noise 11 may be added to produce a distorted signatures of a distorted signature array 218, wherein \dot{s}=s+η.

A decoder 240 may receives and produces r to match the original input random bitstring r. An inverter 250 may then mirror the operation of the decoder 240, inverting r back to the signature s. The network 200 altogether may be referred to as a decoder+inverter, which operates as an auto-encoder that allows learning the latent structure of the signature space. With this auto-encoder, the string r can be considered as a “latent embedding” of the value s from signature space. This latent embedding has enough information for the neural network to correctly handle encoding and decoding even in the presence of errors.

The network 200 may solve two related but different problems. Firstly, it may be configured to decode the signatures to corresponding tags in the presence of errors. Secondly, the model may provide a way to build a large registry of code-words, that is, of tags whose signatures the model is guaranteed to work accurately with. The second requirement is needed because the function ƒ is complex and the choices of tags may in fact result in signatures that no model can distinguish. This cannot be pre-analyzed and must be accounted for in any solution approach. Example embodiments may be configured to meet both requirements. In particular, the decoder+inverter may be trained to determine how to separate the noise from the signal in the signature vectors. Additionally, by using the bottleneck layer to map to r, the network 200 can ensure that these r can act as the index into the code-word registry. This ensures that, post training, providing new r input to the encoder 210 is more likely to lead to usable tag—signature pairs compared to a naive trial-and-error approach of trying random tag—signatures pairs.

### Training

Before any optimization can be performed, the size of the random strings r must be selected. These strings act as input to the Encoder and are the output of the Decoder. The string size is selected in an outer loop that uses a doubling search to find the optimal choice of r. The string size is optimized when the number of bit strings r roughly equals the number of signatures that are far enough apart. This value can be approximated using a bins and balls analysis combined with the doubling search. The other prerequisite for training is a training dataset, which consists of randomly generated tag—signature pairs. Because the space of possible configurations of the tag is known, and the forward function allows mapping tags to signatures, this can be done. Once a specific size for r has been chosen and a training set generated, then the network 200 can be trained.

The first component to be trained may be the decoder+inverter, which acts similarly to an auto-encoder from signatures→random strings→signatures making the random strings act like a latent embedding. Mean squared error loss may be used between the input and the output during this optimization stage. In this example, the signatures (but not tags from the training set) are used for this phase. The end of this phase results in signature—random string pairs. This result can be combined with tag—signature pairs to get tag—signatures—random string 3-tuples. Specifically, a “join” operation on these pairs can be performed to get tags—signatures— random string 3-tuples. Once the decoder+inverter auto-encoder has been trained, the next phase trains the Encoder using mean squared error loss to map the random strings to the corresponding tags in the 3-tuples computed at the end of the first phase of training. At the end of both these phases of training, the result is an encoder that can take random strings r to a tag t, and a decoder that can take signature \dot{s}=ƒ'(t)+η to a random string r (where ƒ′ is the learned response function). To generate the code, unseen random tag—signature pairs and be used, and using the decoder+inverter, random strings can be created that can be used as the tagging ID which is encoded by a physical tag and read as a signature by the scanning technology.

### Conditions on ƒ

To act as a tagging mechanism, a material may be chosen to have measurements that allow the ability to distinguish distance between tags when measured with appropriate precision. That is, distinct tags must map to signatures that are sufficiently far from one another within the signature space to ensure decoding is possible. For simplicity, it can be established that increasing the precision of measurements is captured by an increase in the dimensionality, S, of the signature space vectors.

Distance Preservation: The function ƒ: T→F along with a distance δₛ on S preserves the distance δ_{T} on T if there exist two functions a(S) and b(S) parameterized by the dimensionality of S such that:

$$\frac{b ( S )}{a ( S )} \to 0 as S \to ∞ and : {δ}_{S} ∈ [ a ( S ) \cdot {δ}_{T} \pm b ( S ) ]$$

The distance in the domain T may be scaled by some factor a(S) and perturbed by b(S) (which becomes a smaller fraction of a(S) as S increases). Intuitively, the definition can be interpreted as implying that as long as the noise η does not perturb the distance excessively compared to b(d), there will be sufficient separation of signatures to allow decoding back to tags.

ρ-bounded noise: A noise process ηₛ on vectors s∈S under a distance under a distance metric δₛ is ρ-bounded if:

$${max}_{s ∈ S} \frac{{δ}_{S} ( {η}_{s} )}{{δ}_{S} ( s )} \leq ρ$$

Thus, the worst proportion of the magnitude of noise to that of the true vector among all vectors in S is bounded by ρ.

The neural networks with L hidden layers, ReLU activations, on parameters θ and input x may be represented by ƒ(θ,x). Let Θ^{(L)}(x, x′) represent the NTK expression on input x and x′. Similarly, consider the partial derivative of the network output θ on x and x′; the dot product of these two terms gives the entry corresponding to the kernel that the neural network approximates. A network in example embodiments may satisfy the following theorems:

Theorem 1: Convergence to NTK at initialization. For fixed ∈>0, δ∈(0, 1), with ReLU activations σ(z)=max(0, z), and minimum width of hidden layers lower bounded by

$$Ω ( \frac{{L}^{6}}{{ϵ}^{4}} ln L / δ )$$

Then, for all inputs x, x′ such that ∥x∥≤1 and ∥x′∥≤1:

$$[ \vert 〈 \frac{\partial f ( θ , x )}{\partial θ} , \frac{\partial f ( θ , {x}^{′} )}{\partial θ} 〉 - {Θ}^{( L )} ( x , {x}^{′} ) \vert \leq ( L + 1 ) ϵ ] \geq 1 - δ$$

Theorem 2: Equivalence of trained f and kernel regression. For ƒ as defined above, 1/κ=poly(1/ϵ, log(n/δ)), and the width of all hidden layers lower bounded by a polynomial poly(1/κ, L, 1/λ₀, n, log(1/ϵ)), where λ₀ is the minimum eigenvalue of the NTK, n is the size of the dataset. Any unseen test dataset point x with ∥x∥=1:

$$[ \vert {f}_{nn} ( x ) - {f}_{ntk} ( x ) \vert \leq ϵ ] \geq 1 - δ$$

The above two theorems ensure that the training phases will converge to the NTK, and analyzing the generalization properties of the NTK suffices to understand the generalization properties of the neural networks.

The problem of a large error-correcting code can be abstracted by considering that the set of tags generate a set of points in signature space which is a metric space, and one may estimate the size of the largest collection of points whose error balls (say of radius η) are disjoint in this metric space. This is equivalent to making a graph G on the points with two points being adjacent if they are closer than the error diameter (2η) and estimating the size of the largest independent set in G, that is, the independence number of the graph α(G). However, estimating α(G) is NP-complete (even for points in 2D space), and so a Caro-Wei bound approximation may be used: α(G)≥Σi 1/|Sᵢ| where Sᵢ is the set of points in the neighborhood of point/vertex i, (the neighborhood includes point i itself, i.e. |Sᵢ|=dᵢ+1 where dᵢ is the degree of node i). However, the real-world constraints of scanning applications application do not allow a simple query model to access the neighbors or even the degree of a point in the metric space. Points can only be sampled uniformly randomly in Sᵢ with replacement. This is similar but not quite the setup for the Good-Turing estimator. The following theorem describes the sample complexity of estimating the Caro-Wei bound in the query model defined above.

Theorem 3: Constant-time approximation of α(G). Given a graph G, with N=|V(G)|, there exists an algorithm which finds an approximation of α(G) to within an additive N error with probability at least 1—δ with query complexity:

$$O ( \frac{1}{{ϵ}^{3}} ln \frac{1}{δ} \cdot ln \frac{1}{ϵδ} )$$

The query complexity is independent of |V (G)|, and because none of the intermediate steps require any global computation, this algorithm runs in time independent of the size of the graph and, therefore, works for exponential sized graphs as well.

Constant-time approximation of α(G): Let c=1/∈, sᵢ=|S_{i|}0 for notational simplicity. Example embodiments may perform two approximations to the Caro-Wei bound to estimate the approximation α(G):

$$α ( G ) \geq {\sum }_{i} \frac{1}{{s}_{i}} {\approx }^{( a )} {\sum }_{i}^{k} \frac{1}{{s}_{i}} {\approx }^{( b )} {\sum }_{i}^{k} \frac{1}{\hat{{s}_{i}}}$$

The first approximation (a) uses only k points to approximate the summation instead of all points, and the error may be bound in this step using an additive Chernoff bound. The second approximation (b), computes an estimate sᵢ (by sampling n neighbors of node i) instead of the true value sᵢ because only a limited form of sampling access to the neighborhood of a point may be possible. The estimator for sᵢ bears some similarity to a Good-Turing type estimator, but example embodiments may balance query complexity and error in estimation. The final error can be decomposed into the error introduced by using only k points instead of all N and the error introduced due to the approximation sᵢ instead of sᵢ. In probability terms, the joint probability of two independent events can be bound, which is the same as bounding the product of the individual probabilities. This can be achieved by allocating error probability of √δ for the random selection of the k points and √δ error probability for the estimator. For the total error, because all the terms are being added in the estimates, if an error of ϵ/2 is allocated to each random sampling phase, then the overall will be bounded by ϵ.

The error introduced in step (a) in Equation (2) due to sampling only k points instead of N is done using a standard additive Chernoff bound for i.i.d random variables in [0, 1], with error bound of ϵ/2 and error probability of √δ. This gives a lower bound of:

$$k \geq 4 / {ϵ}^{2} ln \frac{1}{\sqrt{δ}} = 2 / {ϵ}^{2} ln \frac{1}{δ}$$

A sample of n neighbors of i (from Sᵢ), and set sᵢ=min(c, number of distinct points) may be taken. Bounding error: if there are more than c=1/ϵ points in Sᵢ then using sᵢ=c does not introduce more than E error per point i, and therefore it will not violate the final additive approximation. To achieve the required error probabilities, the error of the estimates should be bounded. For the sᵢ<c case, this happens when all points in Sᵢ and for the sᵢ>c case this happens when the samples are not concentrated in a set smaller than c. The following is needed:

n≥2/ϵ·ln2/ϵ\sqrt{δ}=1/ϵ·ln2/ϵδ

As a result, the total sample complexity may be expressed as:

$$kn = \frac{2}{{ϵ}^{2}} ln \frac{1}{δ} \cdot \frac{1}{ϵ} \cdot ln \frac{2}{ϵδ} = O ( \frac{1}{{ϵ}^{3}} ln \frac{1}{δ} \cdot ln \frac{2}{ϵδ} )$$

### Determining Size of R

Example embodiment may determine the appropriate value for R, the dimension of the random bitstring r used before any training can be done. If r is too big, then the training phase will not be affected, however, it may be difficult to use r as a way to generate new tag— signature pairs because the space R is too big and the distribution of usable r in this space might be too sparse to be any use compared to a naive trial-and-error approach. On the other hand, if r is too small then there will not be enough elements in R to allow a large code-word size to be generated as the network 200 may become limited to only using as many code-words as the value of R. Thus, choosing the appropriate value for R may be crucial, and an algorithm to perform a doubling search for the appropriate value for R is described below.

This suggests that the right trade-off between the number of bitstrings R and the number of distinct signatures S is when they are roughly equal, that is, |S|˜|R| so that there are guaranteed a large number of code-words and r can act as an indexing mechanism allowing the picking of tag—signature pairs. In practice, it is not necessary to have any mechanism to determine the value of S precisely, as there may only be access to the fraction p (of R) of bitstrings which were successfully decoded. A bins and balls model may be used to approximate size of S using the knowledge of this fraction p and the current chosen value of R. In this model, the bins correspond to the signatures, and the number of balls can be adjusted to balance (i) hitting a large number of bins without (ii) there being too many balls in the same bin. This approach corresponds to acquiring a large code and being able to use r to index the code-words respectively. This modeling assumes that example embodiments will perform at least as well as randomly matching signatures and the bitstrings r. Because example embodiments may go through training on data with an objective of matching as many distinct signature—bitstring pairs as possible, this criteria may be met.

Theorem 4: Equal bins and balls. If n balls are thrown into m bins then the expected fraction of bins that will be non-empty monotonically decreases as m increases. Further, if n balls are thrown into n bins, then the fraction of bins, p, that will be non-empty is 1— 1/e.

Theorem 4 may be proven by considering the expected number of empty bins. The expectation that a particular bin is empty is the probability of the bin being empty because it is a Bernoulli distribution. Because each ball thrown and bin are independent, the expected number of empty bins then is just the product of this probability with the number of bins. The probability that none of the balls lands in a particular bin gives us (1— 1/m)ⁿ.

$$𝔼 [ number of empty bins ] = {m ( 1 - \frac{1}{m} )}^{n} {\leq }^{( a )} exp ( - \frac{n}{m} ) \cdot exp ( ln m ) = exp ( ln m - \frac{n}{m} )$$

For step (a) the property of the exponential function may be used: 1−x≤e^{-x}. Because the logarithm decreases much slow than any polynomial, this shows that the expectation is decreasing in the number of bins m. To prove the second statement of the theorem, let n=am without loss of generality. Let p be the fraction of bins that are non-empty, so 1−p is the fraction of empty bins. This may be equated with the probability of a bin being empty and may be solved for p such that α=1, and 1−x≈e^{-x}.

$$1 - p = {( 1 - 1 / m )}^{n} ⟹ m \approx n ln \frac{1}{1 - p}$$

$$And α = 1 ⟹ p = 1 - \frac{1}{e}$$

Based on the above theorem, a doubling search may be performed on R (the number of balls) until p≈1−1/e, which implies that S≈R.

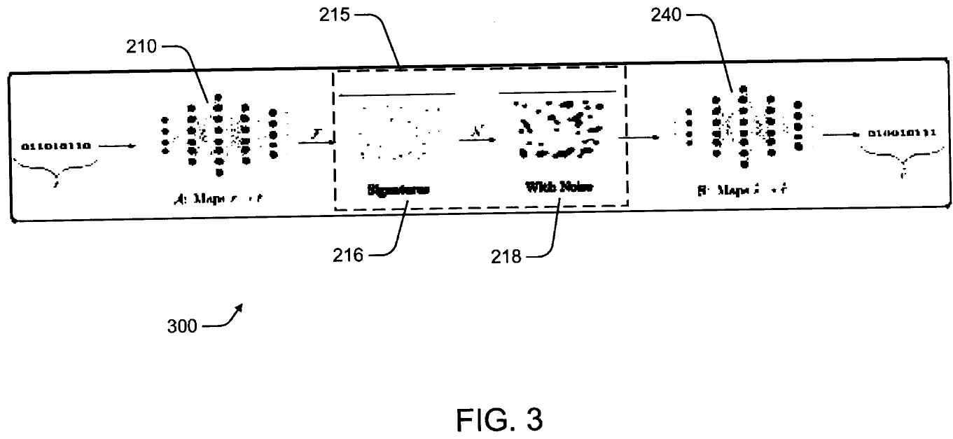

FIG. 3 illustrates an encoder and decoder network 300 in a training configuration. The network 300 may include some or all features of the network 200 described above, and is configured to output a message that can be compared against an input message to provide feedback for training the network. In particular, the encoder 210 maps random bitstrings r to the tags t. This set of tag configurations is then passed to the forward function block 215 that has been learned using the data to mimic the measurement function. This block 215 outputs a signature s of a signature array 216, to which noise η may be added to produce a distorted signatures of a distorted signature array 218, wherein s=s+η. The decoder 240 may receive and produces r to match the original input random bitstring r.

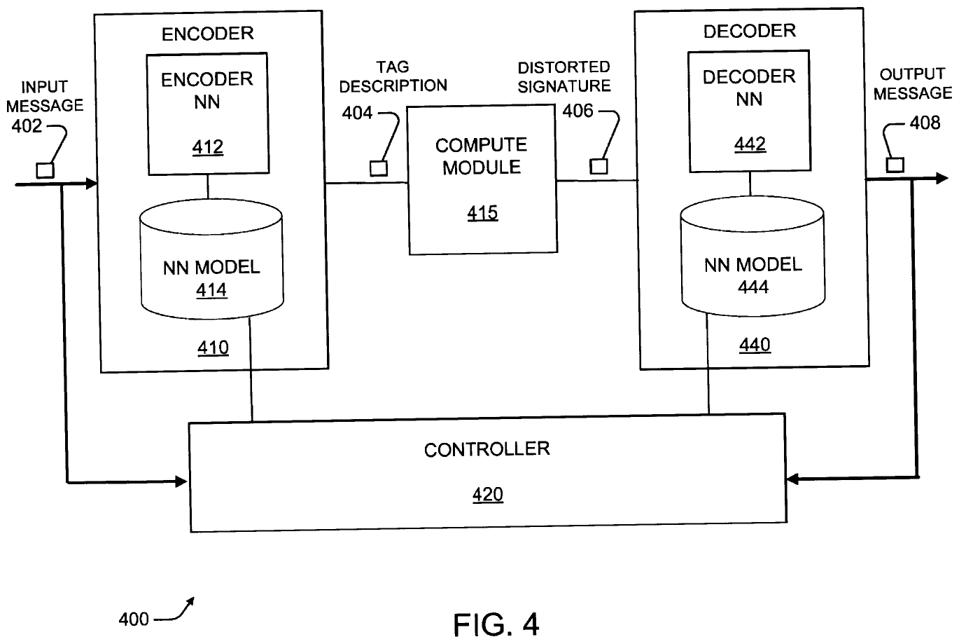

FIG. 4 illustrates a network 400 in a further embodiment. The network 400 may incorporate some or all features of the network 200 described above. In particular, an encoder 410 may be configured comparably to the encoder 210 described above, including an encoder NN 412 configured to operate a NN model stored at a model data store 414. Likewise, a decoder 440 may be configured comparably to the decoder 240 described above, including a decoder NN 442 configured to operate a NN model stored at a model data store 444. A compute module 415 may be configured comparably to the forward function block 215 described above, and a controller 420 may operate to detect output errors and provide appropriate feedback to the encoder 410 and/or decoder 440.

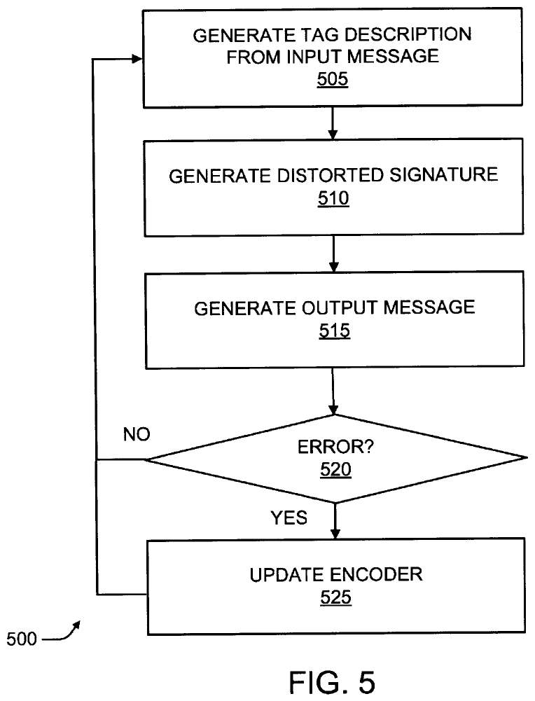

FIG. 5 is a diagram of a training process 500 that may be operated by the networks 200, 300, 400 described above. With reference to FIG. 4, the encoder NN 412 may generate a tag description 404 based on an input message 402 (505). The tag description 404 may include instructions for generating a tag, which is a coded physical representation of the input message 402. For example, the tag description may correspond to a matrix barcode, a radio-frequency identification (RFID) tag, a DNA code, an electronic ink code, a magnetic microwires tag, an optochemical ink tag, or a datacules code. The compute module 415 may then generate a distorted signature 406 based on the tag description 404 and a noise model (510). For example, the compute module 415 may generate a signature based on the tag description, and apply the noise model to the signature to generate the distorted signature. The noise model may be one of an additive white gaussian noise model, a bit-flip model, and a Hamming noise model. The distorted signature 406 may be configured to represent an output of the tag generated by a tag scanning device (e.g., an image, a digital signal, or spectrum data).

The decoder NN 442 may generate an output message 408 based on the distorted signature (515). The controller 420 may receive both the input message 402 and the output message 408 and compare the messages to detect any error in the output message 408 (520). If an error is detected, then the controller 420 may cause the encoder 410 and/or decoder 440 to be updated based on the error (525). For example, the controller 420 may provide the encoder 410 an indication of the error, which the encoder 410 may utilize as training data to further train and update its NN model. Such training may result in the encoder 410 generating subsequent tag descriptions that possess greater distinction over other tag descriptions, enabling the decoder to identify future distorted signatures with greater accuracy. Alternatively, the encoder 410 may respond to an error by increasing the size of the message, thereby creating a larger signature space that enables more distinct features among a population of tags. The decoder 440 may also incorporate the error feedback by training its respective NN model, thereby improving its decoding accuracy when processing subsequent distorted signatures.

Upon training through the process 500, the network 400 may be used, in whole or in part, in a number of encoding and decoding operations. For example, a tag production system may implement the encoder 410 to generate tag descriptions, which are then used to generate physical tags (e.g., matrix barcodes, (RFID) tags) for reading by a tag scanning. Similarly, such a tag scanning device may implement the decoder 440 to accurately decode a signature captured from scanned tags.

While example embodiments have been particularly shown and described, it will be understood by those skilled in the art that various changes in form and details may be made therein without departing from the scope of the embodiments encompassed by the appended claims.

What is claimed is:

1. A network for encoding messages, comprising:
an encoder neural network (NN) configured to generate a tag description based on an input message;
a compute module configured to generate a distorted signature based on the tag description and a noise model;
a decoder NN configured to generate an output message based on the distorted signature; and
a controller configured to 1) detect an error based on a comparison of the input message and the output message, and 2) update the encoder NN based on the error.

2. The network of claim 1, wherein the compute module is further configured to:
generate a signature based on the tag description; and
apply the noise model to the signature to generate the distorted signature.

3. The network of claim 1, wherein the controller is further configured to update the decoder NN based on the error.

4. The network of claim 1, wherein the tag description includes instructions for generating a tag, the tag being a coded physical representation of the input message.

5. The network of claim 4, wherein the distorted signature is configured to represent an output of the tag generated by a tag scanning device.

6. The network of claim 5, wherein the output represented by the distorted signature is one of an image, a digital signal, and a spectrum.

7. The network of claim 1, wherein the noise model is one of an additive white gaussian noise model, a bit-flip model, and a Hamming noise model.

8. The network of claim 1, wherein the controller updates the encoder NN by modifying a size of a message corresponding to the tag description.

9. The network of claim 1, wherein the tag description corresponds to one of a matrix barcode, a radio-frequency identification (RFID) tag, a DNA code, an electronic ink code, a magnetic microwires tag, an optochemical ink tag, and a datacules code.

10. A method of encoding messages, comprising:
generating, via an encoder neural network (NN), a tag description based on an input message;
generating a distorted signature based on the tag description and a noise model;
generating, via a decoder NN, an output message based on the distorted signature;
detecting an error based on a comparison of the input message and the output message; and
updating the encoder NN based on the error.

11. The method of claim 10, further comprising:
generating a signature based on the tag description; and
applying the noise model to the signature to generate the distorted signature.

12. The method of claim 10, further comprising updating the decoder NN based on the error.

13. The method of claim 10, wherein the tag description includes instructions for generating a tag, the tag being a coded physical representation of the input message.

14. The method of claim 13, wherein the distorted signature is configured to represent an output of the tag generated by a tag scanning device.

15. The method of claim 14, wherein the output represented by the distorted signature is one of an image, a digital signal, and a spectrum.

16. The method of claim 10, wherein the noise model is one of an additive white gaussian noise model, a bit-flip model, and a Hamming noise model.

17. The method of claim 10, wherein updating the encoder NN includes modifying a size of a message corresponding to the tag description.

18. The method of claim 10, wherein the tag description corresponds to one of a matrix barcode, a radio-frequency identification (RFID) tag, a DNA code, an electronic ink code, a magnetic microwires tag, an optochemical ink tag, and a datacules code.
